(19) United States
(12) Patent Application Publication
(10) Pub. No.: US 2002/0171027 A1
(43) Pub. Date: Nov. 21, 2002

(54) Food mould made of flexible materials modified for insertion of support and comprising the same

(76) Inventors: Dario Martellato, Noventa Padovana (IT); Alessandro Martellato, Noventa Padovana (IT)

Correspondence Address: FAY, SHARPE, FAGAN,, MINNICH & McKEE, LLP, Seventh Floor, 1100 Superior Avenue, Cleveland, OH, 44114-2518, US

(21) Appl. No.: 10/101,811

(22) Filed: Mar. 19, 2002

(30) Foreign Application Priority Data
Mar. 19, 2001 (IT) MI2001U000158

(51) Int. Cl. A21C 11/00

(52) U.S. Cl. 249/160; 249/DIG. 1; 425/186

(57) ABSTRACT

A food mould made of flexible materials, such as for example silicone material, featuring an edge modified in such a way as to permit the insertion of a support of different height in order to make the mould non-deformable and stable when gripped, is described. The support to be inserted in the mould has the same shape as the mould itself and its dimensions are such as to permit insertion of the same in the appropriately modified edge of the mould.

### FIELD OF THE INVENTION

The invention consists of a food mould modified in such a way as to permit the insertion of a support in order to make the mould non-deformable and stable when gripped, and comprising said support.

### BACKGROUND OF THE INVENTION

Moulds made of flexible or in any case deformable materials, for example silicone material, for cooking and refrigeration of food, in particular but not only cakes and pastries, are known and widely used both at artisan-industrial and domestic levels. The main characteristic of these moulds is the fact that they are versatile and inexpensive to use. They can be used both for the refrigeration of food, for example ice-cream and ice-cream cakes, at extremely low temperatures (−140° F., −60° C.), and for cooking food, for example cakes, at very high temperatures (+539° F., +280° C.) as they are thermally stable and resistant to chemical agents, non-toxic and very easy to handle during loading and unloading of the food to be refrigerated or cooked or already refrigerated or cooked. They are also easy to maintain and can be cleaned in compliance with the current health and hygiene regulations.

The moulds in question can be of various dimensions and geometrical shapes (circular, hexagonal, octagonal etc.) or they can be fantasy shapes like trees, fruit or animals for example. Their common characteristic is that they generally have large dimensions and are designed to contain fairly heavy food (cakes, ice-cream cakes or other).

The silicone material usually used is very flexible and soft, thus creating problems of movement and instability of the moulds when they contain the food to be cooked or refrigerated. In particular, gripping of the mould on the outer edge is awkward and difficult. The above-mentioned characteristics of the moulds, made of silicone for example, cause deformation of the mould when it is gripped and lifted, with consequent outflow of the liquid, semiliquid or pasty contents or breakage of the solid or semisolid contents.

The modified moulds object of this invention overcome said problems in use of the moulds.

For this purpose the edge of the mould has been modified to permit the insertion of a support which makes the moulds stable and non-deformable when they are gripped and lifted.

### SUMMARY OF THE INVENTION

The object of the present invention is a modified food mould made of flexible material characterised by a purposely extended and folded edge to permit the insertion of a support with height equal to or different from the mould itself and comprising said support.

The support can be slotted into the edge of the mould or moulded into it and follows its perimeter, reproducing its section at least in the part where contact occurs between said edge and said support.

### BRIEF DESCRIPTION OF THE DRAWINGS

The invention will be better described below with reference to embodiments having a non-restrictive character illustrated in the attached figures where:

FIG. 1 shows a perspective view of a section of a modified mould with the support (2) positioned in the edge (1) having a height equal to that of the folded edge (1);

FIG. 2 shows a perspective view of a section of a modified mould with the support (2) positioned in the edge (1) having a height higher than that of the folded edge (1) and equal to that of the mould itself;

FIG. 3 shows a perspective view of a section of a modified mould with the rigid support (2) incorporated in the modified edge (1).

### DETAILED DESCRIPTION OF THE PREFERRED EMBODIMENT

The invention described here consists of a mould modified to permit insertion in the edge (1) of a support (2) which reproduces its section at the point of contact between said edge (1) and said support (2), in order to make the mould stable and easy to handle when gripped, and comprising said support. For a heart-shaped modified mould, for example, the support will also be heart-shaped.

The support (2) is positioned or incorporated in the edge (1) of the mould, which is purposely extended until it entirely covers said support in order to accommodate the latter inside it.

In the first case, when the support (2) is slotted into the mould, it can be glued to the edge or movable. In this case the support (2) is inserted in the modified edge (1) by simply pressing it in. The removable support has the advantage of permitting cleaning or replacement in the event of breakage and therefore the support (2) is preferably movable.

If, on the other hand, the support (2) is incorporated in the edge (1) of the mould, it is inserted in the same by moulding and is therefore fixed. The support (2) must be made of materials with good thermal conductivity and thermally stable and therefore of materials resistant to heat, at least up to 250° C., and to low temperatures, and can be made either of plastic material (for example Stanyl 46 TE 200 F6 or equivalent materials) or other materials, such as ceramic or metal, compatible as regards thermal characteristics (for example thermal dilation and heat permeability) with the materials of the moulds and with the envisaged uses of the same in freezing, cooking or processing at ambient temperature. Said support (2) can also consist of several materials or be covered with different materials. In any case the materials used, also in combination, for said support (2) must have thermal characteristics (for example dilation) compatible with one another and with the envisaged uses of the modified moulds.

The edge (1) of the modified mould that houses the support (2) has a width of between 5 and 50 mm and a height of between 2 mm and the full height of the mould or even higher than the same if required by the shape of the mould.

The width of the support (2) must be compatible with that of the edge (1) in which it is inserted and is between 1 and 48 mm; the height of the support (2) can vary from a minimum of 1 mm up to the height of the mould itself or even higher depending on the type of mould.

Where necessary due to the particular shape of the mould, for example hemispherical or pyramidal, in which case it has very little stability of its own, the support (2), whether slotted or moulded into the edge (1), can exceed the height of the mould itself to give it further stability.

In any case the section of the support (2) must be equal to the edge (1) of the modified mould at least in the part where contact occurs, while in the other part it can be of uniform section, although the dimensions do not necessarily have to be the same. Furthermore the section of the other part of the support (2) or also the side parts can be fantasy shapes or shaped according to functional requirements, for example tripod-shaped, knurled, perforated, with handles, corrugated, decorated etc. Consequently the dimensions of the contact section, and in particular the perimeter and width of said support (2), can differ according to the dimensions of the mould and the edge (1) but must be appropriate, with respect to those of the mould and the edge (1), for stable insertion of said support (2) in the edge (1), when it is either slotted or moulded into the edge (1) of the mould.

The support (2) can furthermore be polished or rough to improve the grip and can be of various colours.

For the sole purpose of illustrating possible embodiments of the invention, some examples of modified moulds comprising the support shown in the attached figures are described below in detail.

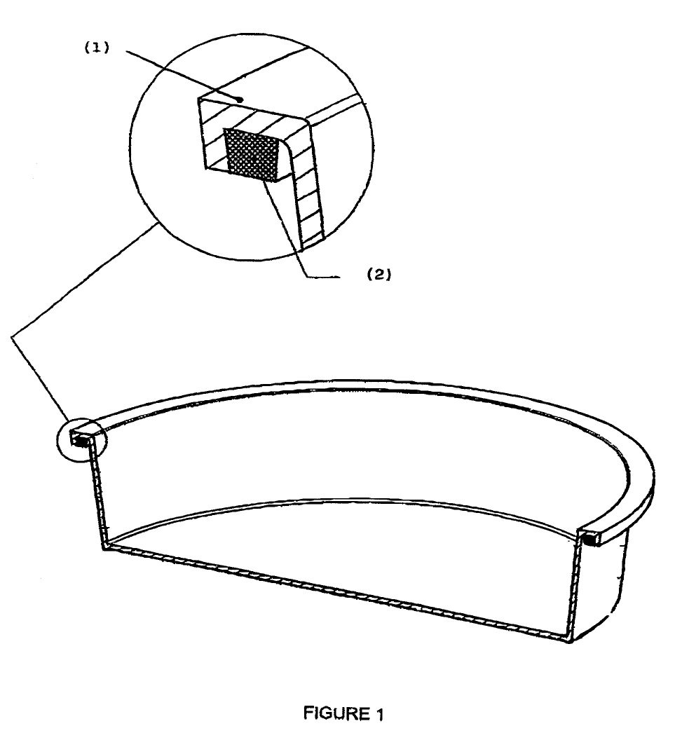

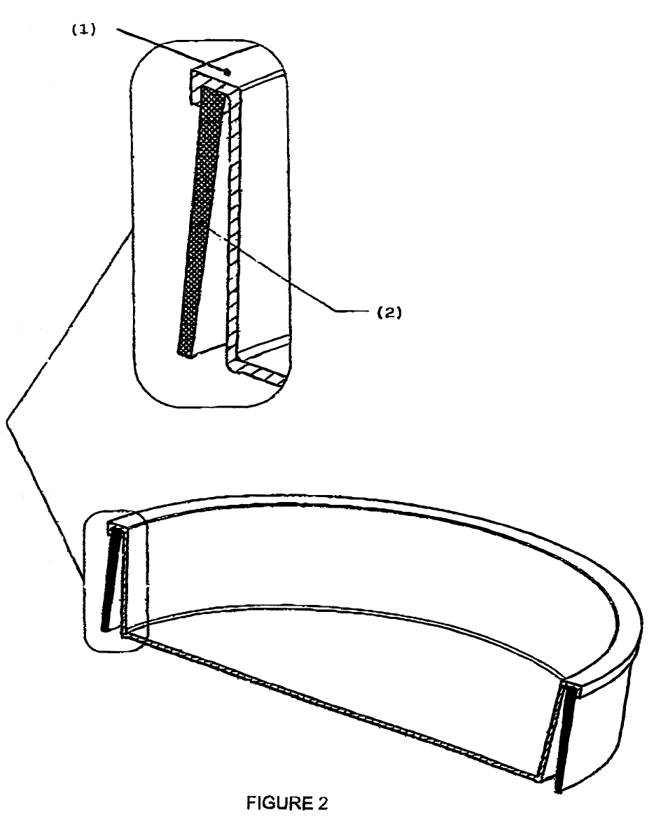

FIGS. 1 and 2 show a perspective view of a section of a food mould modified for insertion of a support (2) slotted into the edge (1) of the mould. In particular, in order to provide convenient and stable insertion of the support (2), the edge (1) of the mould is extended and folded to permit insertion of said support (2) in the edge (1). The flat part of the edge (1) in question has a width of 10 mm, while the folded part of the edge (1) has a height of 5.0 mm.

The support (2) of FIG. 1 has the following dimensions: width 5 mm and height 3 mm. The support (2) of FIG. 2 is 5 mm wide and is the same height as the mould.

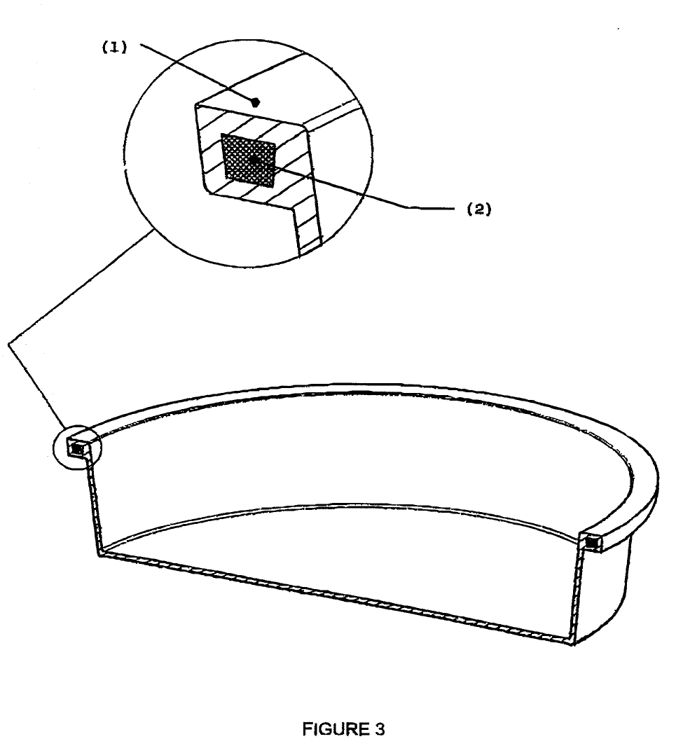

FIG. 3 shows a perspective view of a section of a food mould modified for the insertion of a support (2) moulded into the edge (1) of the mould. In this case the dimensions are the same as the mould of FIG. 1.

The modified mould as described comprising the support (2) is therefore substantially non-deformable when gripped and lifted, consequently overcoming the problems encountered with the moulds currently used.

The invention therefore has the advantage of: improved gripping of the mould, elimination of the deformability typical of food moulds made of silicone material used both in industrial and domestic applications, and greater mould consistency also during the food processing phase.

While remaining within the scope of the invention, it is possible for a expert in the art to make all the possible modifications and improvements suggested by natural technical development to the mould modified for the insertion of a support and comprising said support, object of the present invention.

What is claimed is:

1. Modified food mould characterised by an extended and folded edge for the insertion of a support of the same section as the mould, at least in the part where contact occurs, and comprising said support.

2. Modified mould as in claim 1 where the width of said edge is between 5 mm and 50 mm and the height is no lower than that of the mould and in any case no lower than 2 mm at least.

3. Modified mould as in claim 1 where the width of said support is between 1 and 48 mm and the height is no lower than that of the mould and in any case no lower than 1 mm at least.

4. Modified mould as in claim 2 where the width of said edge is 10 mm and the height is 5 mm.

5. Modified mould as in claim 3 where the width of said support is 7 mm and the height is no lower than that of the mould and in any case no lower than 1 mm.

6. Modified mould as in claim 1 where the support is slotted into the edge (1) of the same mould.

7. Modified mould as in claim 6 where the support is positioned in such a way as to be removable.

8. Modified mould as in claim 1 where the support is moulded into the edge (1) of the same mould.

9. Modified mould as in claim 1 where the support is made of one or more materials, also combined, thermally stable and with thermal characteristics compatible with one another.

10. Modified mould as in claim 1 where the support is of uniform section with respect to the same mould.

11. Modified mould as in claim 1 where the support in the part not inserted in the edge (1) has a section different from the same mould.

12. Modified mould as in claim 11 where the support in the part not inserted in the edge (1) is tripod-shaped, knurled, perforated, with handles, corrugated or decorated.

13. Modified mould as in claim 1 where the support is polished or rough and in different colours.
